(19) United States
(12) Patent Application Publication
(10) Pub. No.: US 2006/0221603 A1
(43) Pub. Date: Oct. 5, 2006

(54) Bi-directional flashlight

(76) Inventors: John P. Zazzara SR., So. Plainfield, NJ (US); James J. Denker, Monmouth Beech, NJ (US)

Correspondence Address: JOHN P. ZAZZARA SR., 203 OAK MANOR PKWY, SO. PLAINFIELD, NJ, 07080, US

(21) Appl. No.: 11/097,753

(22) Filed: Apr. 4, 2005

(51) Int. Cl. F21L 4/00

(52) U.S. Cl. 362/187; 362/184

(57) ABSTRACT

The double-ended flashlight having two conductive barrels and a double ended tailcap insert which provides for enhanced mechanical and electrical contact between the barrel and the batteries, provides for retaining two tailcap springs, one on each end, to the tailcap upon removal of the tailcap from one or both barrels, provides retainers to prevent the tailcap insert contacts from over radial extension and to prevent ingress of material from ambient to within the battery housing.

### BACKGROUND OF THE INVENTION

1. Field of the Invention

The present invention relates primarily to flashlight improvements, and in particular, to hand-held flashlights having a tailcap insert of the type generally disclosed in U.S. Pat. No. 4,819,141.

2. Discussion of the Prior Art

Flashlights of varying sizes, shapes and power supplies are well-known, including flashlights having a tailcap insert of the type shown in U.S. Pat. No. 4,819,141. In general such flashlights incorporate inserts of this general type in order to eliminate several machining steps during manufacture of the flashlight and to maintain a high degree of electrical continuity within the electrical circuit in the tailcap region of the flashlight. It has been observed that with known tailcap inserts of the type shown in U.S. Pat. No. 4,819,141 the lateral forces exerted on wings of the insert are sometimes insufficient to exert a tight mechanical fit between the wings and the inside surface of the barrel at the tailcap end of the flashlight.

Also, the tailcap coupler of the general type disclosed in U.S. Pat. No. 4,819,141 permit two flashlights to be matted end-to-end.

The present invention seeks to improve the flashlight art in accordance with the hereinafter stated objects of the present invention.

### OBJECTS OF THE INVENTION

It is an object of the present invention to provide a hand-held bi-directional flashlight having a tailcap coupler having enhanced ability to emit light form equal and opposite direction as required by the user.

It is another object of the present invention to provide a tailcap coupler insert having the abillity to attach two similar separately switchable flashlights end-to end.

It is a further object of the present invention to provide a tailcap coupler having an improved ability to retain the tailcap springs attached to the tailcap coupler upon removal of the tailcap from either barrel.

It is a further object of the present invention to provide a bi-directional hand-held flashlight having provision for accomplishing any combination of the above stated objectives.

These above stated and other objects of the present invention, which may become obvious to those skilled in the art from the hereinafter detailed description of the preferred embodiments of the invention, may be achieved by a flashlight according to the present invention.

### SUMMARY OF THE INVENTION

The present invention is directed to a bi-directional flashlight having at its tailcap an improved tailcap coupler and dual spring retainer.

One embodiment of the tailcap coupler of the present invention provides a generally cylindrical, electrically conductive tubes having threaded tailcap springs upon compressed upon insertion of batteries and subsequent assembly of the bi-directional flashlight assembly.

### BRIEF DESCRIPTION OF THE DRAWINGS

FIG. 1 is a foreshortened, front perspective view of the bi-directional flashlight with the tailend coupler of the present invention.

### DETAILED DESCRIPTION OF PREFERRED EMBODIMENTS

In flashlights of the general type shown in U.S. Pat. Nos. 4,577,263 and 4,658,336, advantageous use is made of a tailcap insert of the general type shown in U.S. Pat. No. 4,819,141. Although the present invention may be used with virtually any size and type of flashlight, the following descriptions relate to uses in flashlights of the type set forth in the above-referenced patents.

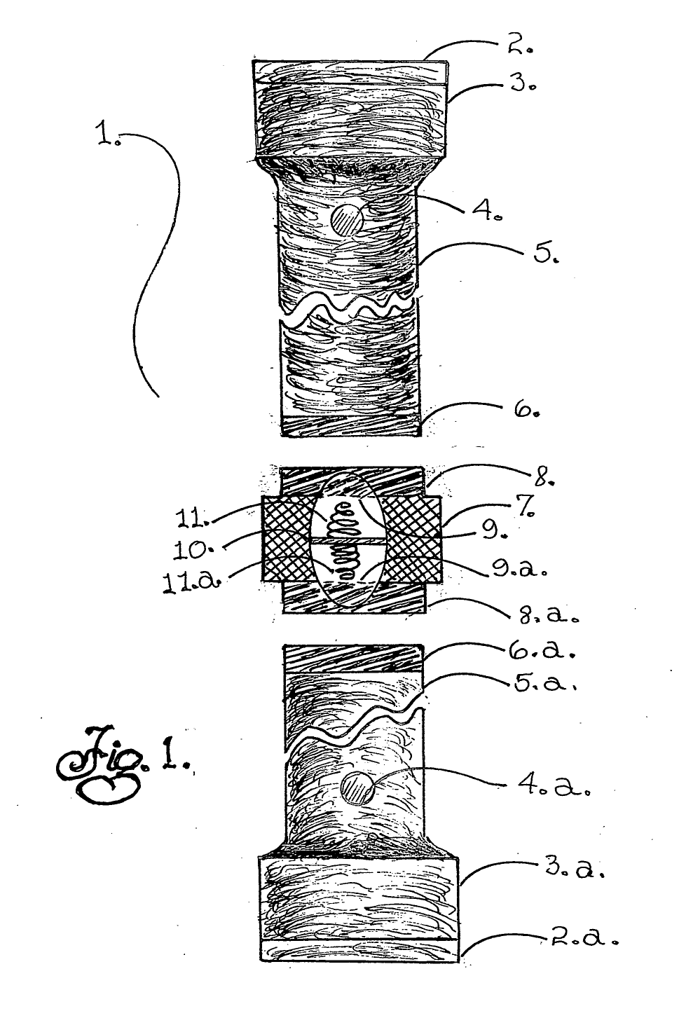

Referring to FIGS. 1, a tailcap or dual end coupler 7 is shown. The tailcap coupler 7 has a generally tubular shaped body having a longitudinal slot 9 and 9a formed along one side of its length thereof and a dual spring retainers 11. and 11a. at its forward end. The negative ground plate 10 functions to provide an electrically conductive path between the battery and each conductive barrel 5. and 5a. of a bidirectional metal flashlight 1.

The dual tailcap coupler 7 of the present invention may be made of any suitable conventional conductive material, such as for example, beryllium copper, or other materials which provide good electrical conductivity as well as good mechanical strength.

In a preferred embodiment, the tailcap insert 7 has two threaded contact ends 8. and 8a. as shown in FIG. 1. Each contact thread 8 and 8a. extends from the main body portion of the tailcap coupler 7. The contact threads will, upon insertion of the tailcap assembly into each threaded barrel end 6. and 6a. having batteries, cause a force to be applied against negative contact springs 11. and 11a.

Referring to FIG. 1 the conductive barrels 5. and 5a. shown each having on-off control switches 4. and 4a. and barrel extension threads 6. and 6a.

In its assembled condition, as shown in FIG. 1, the tailcap coupler 7. screws into the tail end of barrels 5. and 5a. at barrel threads 6. and 6a. and tailcap threads 8. and 8a. respectively. As further shown in FIG. 1, the compressive force exerted on spring 9. and 9a by the action of battery and tailcap coupler. The outermost portion of the conductive barrels 5 and 5a. forming a tight mechanical fit up against the inner surface of the endcap coupler surfaces 6. and 6a. thus forming an electrical contact of enhanced certainty and reliability. Also, as shown in FIG. 1, each lens and reflector retainer 2. and 2a. along with the rotatable focusing mechanism allow the focal point of the light output to be adjusted as required by rotating the focusing mechanism 3. and 3a. of the lamp retainer portions 2 and 2a.

While I have described preferred embodiments of the herein invention, numerous modifications, alterations, alternate embodiments and alternate materials of construction may be contemplated by those skilled in the art and may be utilized in accomplishing the present invention. It is envisioned that all such alternate embodiments are considered to be within the scope of the present invention as defined by the appended claims.

What is claimed and desired to be secured by Letters Patent of the United States is:

1. A bi-directional flashlight assembly with two rotatable heads, one on each end acting as a focusing mechanism, said assembly comprising:
twin elongated hollow metal housings containing at least two batteries, and having a threaded forward end for receiving a flashlight head;
each flashlight head carrying a seven bulb holder (one incandescent and six led bulbs) and a reflector, said flashlight head being threadedly mounted upon said forward end of said housing in electrically insulated relation thereto;
said bulb holder having two terminals for carrying electrical current, one being in conductive engagement with said flashlight head and the other having associated spring contact means providing a current conducting path to said battery;
means providing a conductive path between said battery and said housing;
said housing having on the extremity of its forward end a flat annular face; and said flashlight head having a flat annular face adapted for mating engagement with said face of said housing, whereby the rotation of said head to allows the focal point of the light beam to be adjusted.

2. The insert of claim 1 wherein the means to force includes the two springs positioned on each end of the tailcap coupler assembly.

3. The insert of claim 2 further including a plurality of resilient means for retaining the conical spring in attachment to said tailcap coupler upon removal of said tailcap from each said barrel.

4. A flashlight assembly as in claim 3 wherein said housing one each end is threaded on its interior wall, wherein the rearward end of each said flashlight head is of reduced diameter, and which further includes a coupler member made of metal material and which is of a generally ring-shaped configuration, the inner wall of said coupler member being threadedly secured upon said reduced diameter rearward end of one said flashlight head while the outward wall of the opposite end said coupler member is threaded and engages the threads on the interior wall of the other said housing.

5. In a dual flashlight assembly having two metal housing segments with threaded ends and two metal flashlight heads threadedly supported therefrom, and wherein relative rotation between the head and the housing is employed for adjusting the focal point of light output.
